(19) United States
(12) Patent Application Publication
(10) Pub. No.: US 2011/0246465 A1
(43) Pub. Date: Oct. 6, 2011

(54) METHODS AND SYSEMS FOR PERFORMING REAL-TIME RECOMMENDATION PROCESSING

(75) Inventors: Jari Koister, Menlo Park, CA (US); Erik Gustafson, Bromma (SE)

(73) Assignee: salesforce.com, inc., San Francisco, CA (US)

(21) Appl. No.: 12/987,932

(22) Filed: Jan. 10, 2011

Related U.S. Application Data
(60) Provisional application No. 61/319,752, filed on Mar. 31, 2010.

(51) Int. Cl. G06F 17/30

(52) U.S. Cl. 707/737; 707/775; 707/E17.014; 707/E17.089

(57) ABSTRACT

Methods and systems are presented for recommending similar questions to one that a user has entered into a search engine. Previously-entered questions are subject to a clustering algorithm and placed into a hierarchy of clusters, with clusters set within clusters. For each cluster within the hierarchy, a representative vector, based on feature vectors of the items within the cluster, is calculated. A feature vector for the user's question is calculated and used, along with the representative vectors at each level in the hierarchy, to traverse and navigate the cluster hierarchy. When a leaf cluster is found, the items in the leaf cluster, such as the previously-entered questions are returned to the user. A subset of items in the leaf cluster, or items from other leaf clusters within a branch cluster, can be selected based on the number of items desired to be returned.

### CROSS-REFERENCES TO RELATED APPLICATIONS

This application claims the benefit of U.S. Provisional Application No. 61/319,752, filed Mar. 31, 2010 (Attorney Docket No. 021735-009300US), which is hereby incorporated by references in its entirety for all purposes.

This application is related to U.S. application Ser. No. ______, filed Jan. 10, 2011 and titled “Methods and Systems For Implementing a Compositional Recommender Framework” (Attorney Docket No. 021735-010110US), which is hereby incorporated by reference in its entirety for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

1. Field of the Art

The present invention generally relates to making recommendations in an online search, and more particularly to recommending similar questions that had been asked before and/or their corresponding answers and presenting them to users of an on-demand database and/or application service.

2. Discussion of the Related Art

Finding an answer to a particular question online can sometimes be a frustrating experience. A user looking for information may have an inkling that someone else has sought the same information before, but the user may not know how others found the answer. The user may even have trouble articulating a question for typing into a search engine.

Without the proper keywords, such as keywords peculiar to the domain of the topic, the user may find it to be a daunting process to find an answer to his or her question with an online search engine. In this respect, a user who is brand new to a topic has a severe disadvantage to finding the information he or she seeks. However, even with a little expertise and the proper keywords, a search using keywords may be next to useless because some keywords have multiple meanings depending on their context. For example, “apple” in one context can mean something completely different than “apple” in another context. Determining context from other words in a search can help if there are enough other words. However, other words may simply confuse the issue and bring up even more unrelated search results.

The problems above arise often in corporate networks that host on-demand databases and applications. Computer users often refer to the same computer issue or problem in different ways, and the terminology everyone uses is often overloaded and/or not universally accepted. For example, the term “module” has many meanings. It may be software, and that software many exist at different levels of a computer, such as a module in a low-level driver or a module add-in in an application. In other cases, the term “module” can refer to hardware components.

A user may be confronted with a problem that another user at another company had with an on-demand database, the on-demand database that both users share. However, the user no confronted with the problem has little-to-no way of finding out what questions were asked previously. Because the users are at different companies, they typically are not aware of each other and are not cc'd with each other's answers to questions that arise.

A better way of recommending questions to ask and obtaining information in general is needed.

### BRIEF SUMMARY

Generally, methods and systems in search engines for recommending a question to ask and obtaining answers to the question using a hierarchy of clusters of questions are described. Previously-asked questions, and optionally corresponding answers, are stored in a database. A “feature vector” that quantifies the content of each previously-asked question, and optionally their answers, is calculated. The previous questions/answers are then clustered with respect to each other using their feature vectors. Clusters are clustered themselves so that there are super-clusters, sub-clusters, etc. into a hierarchy of clusters. A representative vector is created for each level of the hierarchy, the representative vectors based on the feature vectors underneath each respective level. A user's question is received, and a feature vector is calculated for it. The user's question's feature vector is then used along with the representative vectors at each level of the hierarchy to navigate the hierarchy to an end, leaf cluster. The contents of the leaf cluster, which contains the closest previously-asked questions to the user's question, are then returned to the user.

If there are too many previously-asked questions in the leaf cluster to return, then the user's question's feature vector can be compared with each of the previously-asked question's feature vectors in the leaf cluster. This is beneficial in that it significantly lowers the processing costs. For example, it is more efficient to search only twenty previously-asked questions (in a leaf cluster) than it is to search hundreds, or thousands, of previously-asked questions scattered across a database.

Once a leaf cluster is found, the user's question can be added to the leaf cluster in order to add to the database. Upon adding the user's question to the leaf cluster, it can be determined whether to subdivide the leaf cluster into more clusters.

Some embodiments relate to a method for performing recommendation processing. The method includes receiving a query from a user, creating a feature vector for the query, the feature vector based on content of the query, and traversing, using a processor operatively coupled with a memory, a cluster hierarchy, the cluster hierarchy having clusters within clusters, each cluster of the cluster hierarchy having a representative vector, each representative vector based on at least one feature vector of an element within the respective cluster. Traversing includes finding a closest cluster by comparing the feature vector of the query with representative vectors of clusters at a level in the hierarchy, and comparing, based on the finding, the feature vector of the query with representative vectors of clusters within the closest cluster. The method further includes sending one or more elements in the closest cluster to the user.

Some embodiments relate to a method for performing recommendation processing. The method includes clustering pre-existing entities into a cluster hierarchy, each level of the hierarchy having a representative vector, receiving a query from a user, creating a feature vector for the query, traversing, using a processor operatively coupled with a memory, the cluster hierarchy, comparing the feature vector of the query to at least one representative vector in the cluster hierarchy to find a closest cluster, and sending one or more pre-existing entities in the closest cluster to the user.

Some embodiments relate to a method of building a cluster hierarchy for recommendation processing. The method includes receiving items to be clustered, each item having a feature vector, clustering, using a processor operatively coupled with a memory, the items into leaf clusters, determining a representative vector for each leaf cluster, the representative vector of each leaf cluster based on at least one feature vector of the items within the respective leaf cluster, clustering the leaf clusters into branch clusters, and determining a representative vector for each branch cluster, the representative vector of each branch cluster based on at least one representative vector of the leaf clusters within the respective branch cluster.

Embodiments also include machine readable tangible storage mediums carrying instructions and computer systems, including an on-demand database service, executing instructions to perform the above methods.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

FIG. 1 illustrates a block diagram of an environment wherein an on-demand database service might be used.

FIG. 2 illustrates a block diagram of an embodiment of elements of FIG. 1 and various possible interconnections between these elements according to an embodiment of the present invention.

FIG. 3 illustrates an active query page in accordance with an embodiment.

FIG. 4 illustrates a feature vector in accordance with an embodiment.

FIG. 5 illustrates a single cluster in accordance with an embodiment.

FIG. 6 is an alternate representation of the cluster of FIG. 5.

FIG. 7 illustrates a cluster hierarchy in accordance with an embodiment.

FIG. 8 is an alternate representation of the cluster hierarchy of FIG. 7.

FIG. 9 is a process diagram in accordance with an embodiment.

FIG. 10 is a process diagram in accordance with an embodiment.

FIG. 11 is a process diagram in accordance with an embodiment.

### DETAILED DESCRIPTION

The present application relates to methods and systems for recommending similar questions to a question that a user has entered into a search engine. Answers to the user's question can also be recommended. Questions that other users previously entered are organized into clusters, and those clusters are placed into a hierarchy. The clustering may be performed by calculating a feature vector for each question, or the clustering may be performed by other advanced clustering algorithms as known in the art. Each cluster in which there are questions is also given its own feature vector, named a representative vector. The representative vector is representative of questions (and their respective feature vectors) within the cluster.

When a user types in a query, a feature vector is calculated for the query. The cluster hierarchy is then traversed, using the representative vectors of each cluster in the hierarchy, until a leaf cluster is found. The previously submitted questions in the leaf cluster are then sent to the user. Alternatively, the hierarchy can be traversed until a threshold number of questions in levels below the current level are found.

Technical advantages of embodiments are many. These techniques can be used for entities/items that do not already exist in a database, such as a user's recently typed-in question, as opposed to entities/items that already exist in a database, such as movie titles in a movie-rental database or book titles in a bookseller's database. Clustering algorithms, which generally take a great deal of computational time and therefore are avoided for real-time searches, can be used for real-time searches. The use of clustering algorithms, as opposed to simple text and string matching, can greatly improve the relevance of search results.

According to one embodiment, clustering and metadata-based techniques are combined, and similarity calculations and feature vectors are used to find items that are similar to a new user created items, in real time. Initially, a background system takes the following inputs:

1. Some set of data items. These can be sets of users, documents, discussions, wiki pages, questions, etc. For each item, a characterization hereby called a “feature vector” is created. Feature vectors can be of different forms and depend on various attributes, metadata, etc. of the item.
2. A similarity measure that assigns similarity a value to the similarity of two distinct feature vectors.
3. A clustering algorithm that uses feature vectors, similarity algorithms and other data to structure items so that items similar are closely associated with each other.

These inputs are used as input to a clustering engine that created a cluster. A traditional recommendation engine would use a cluster to identify items that are similar to a specific item also in the cluster.

The methods and systems here are useful in corporate network settings, including those whose databases are hosted on an on-demand database service. On-demand database services are well suited for such technologies because the clustering and search engines can be offered as an expedient service to clients. If a client wishes to have recommended questions using clustering, then an embodiment can be activated without having to install software on the client's own hardware network.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

System Overview

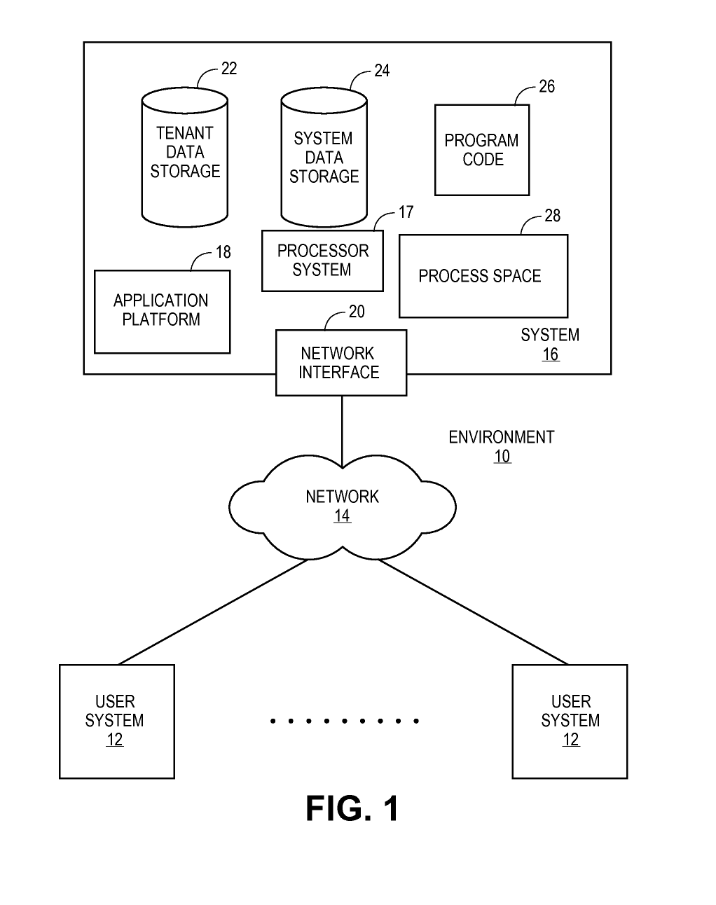

FIG. 1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

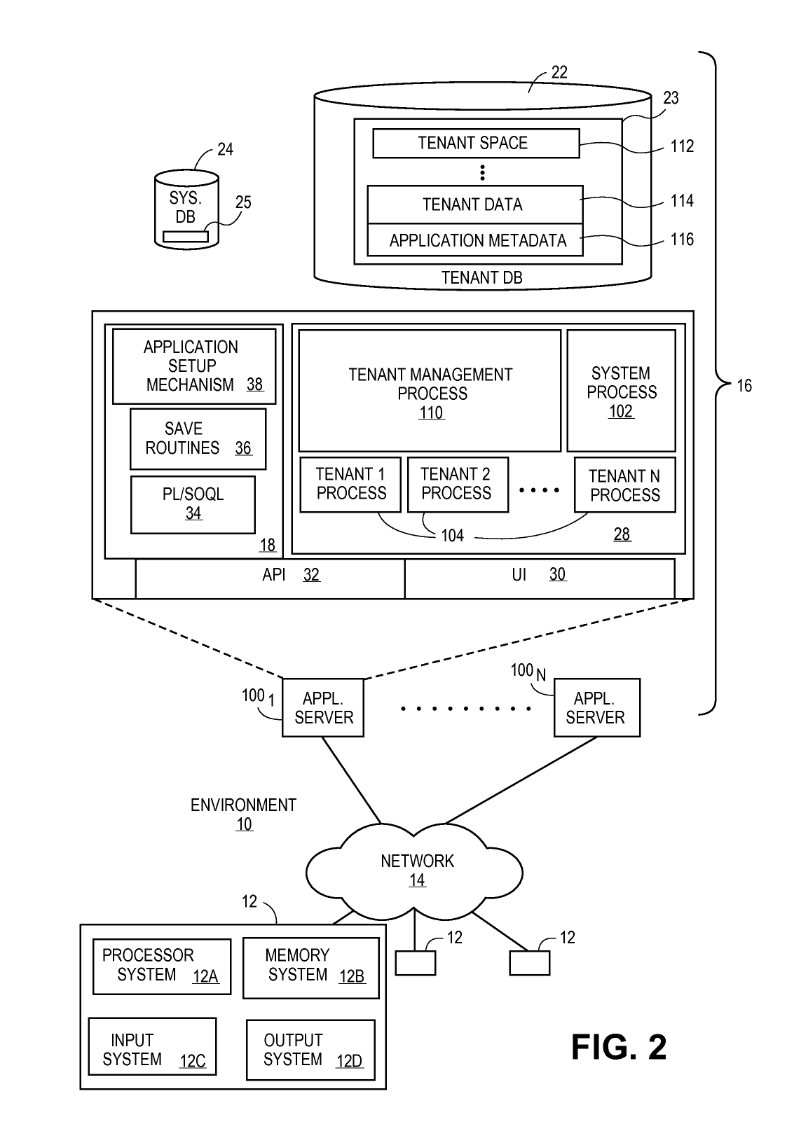

Environment 10 is an environment in which an on-demand database service exists. User system 12 may be any machine or system that is used by a user to access a database user system. For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the present invention might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications (application processes) as well as provide related data, code, forms, web pages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 10. However, in FIG. 2 elements of system 16 and various interconnections in an embodiment are further illustrated. FIG. 2 shows that user system 12 may include processor system 12A, memory system 12B, input system 12C, and output system 12D. FIG. 2 shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned U.S. Provisional Patent Application 60/828,192 entitled “Programming Language Method and System for Extending APIs to Execute In Conjunction With an On-Demand Database Service,” by Craig Weissman, filed Oct. 4, 2006, which is incorporated in its entirety herein for all purposes. Invocations to applications may be detected by one or more system processes, which manages retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

A table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. Yet another table or object might describe an Opportunity, including fields such as organization, period, forecast type, user, territory, etc.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System,” and which is hereby incorporated herein by reference, teaches systems and methods for creating custom objects as well as customizing standard objects in a multi-tenant database system.

Real-Time Recommendation Processing

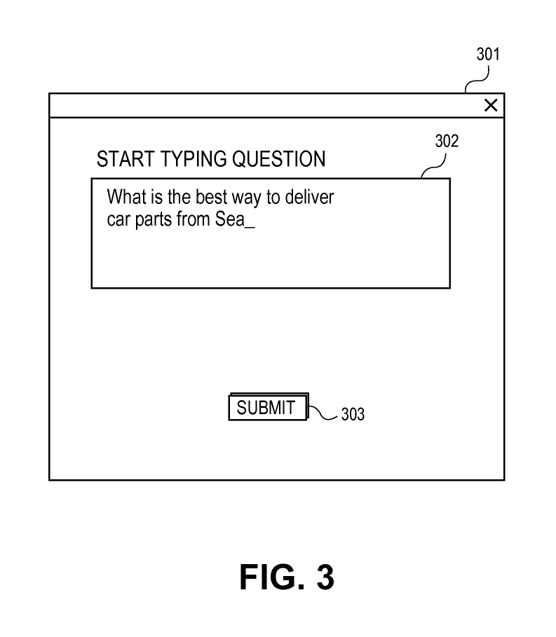

FIG. 3 illustrates an active query page in accordance with an embodiment. In active query page 301, a user begins to type a query (i.e. “What is the best way to deliver car parts from Sea_”) in multi-line textbox 302. While the user is typing, the query is analyzed in real-time to calculate its feature vector. That feature vector is used to traverse a hierarchical cluster hierarchy in the background. Before the user has finished his sentence or pressed submit button 303, the system can show similar questions that other users have asked. For example, one suggested question may be “How to send vehicle spares from Seattle?” or “Shipping GM parts out of the Seattle area.” These can be shown in a drop down box, in the status bar, in tool-tip text, or other areas of the screen for the user.

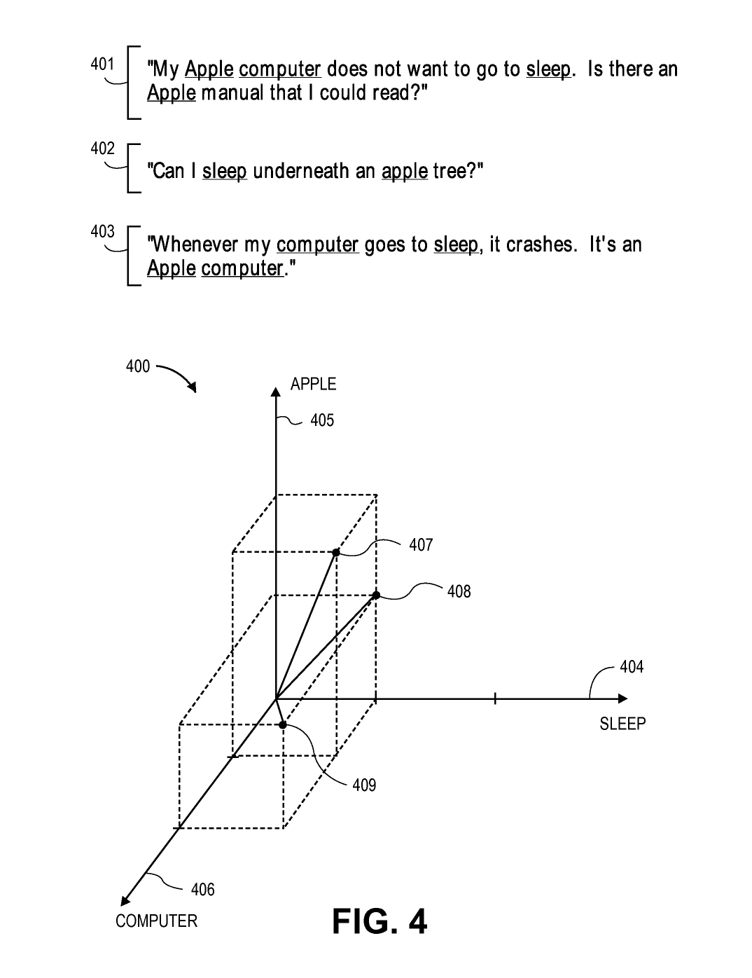

FIG. 4 illustrates simple feature vectors, related to semantic footprints, in accordance with an embodiment. Feature vectors are sometimes called categorization vectors. Each feature vector in the figure is represented in 3-D chart 400, which plots the number of particular keywords in a passage. Each of the orthogonal axes on the chart represents a particular keyword. Axis 404 represents “sleep,” axis 405 represents “apple,” and axis 406 represents “computer.”

Query 401, “My Apple computer does not want to go to sleep. Is there an Apple manual that I could read?”, has one instance of the word “sleep,” two instances of the word “Apple,” and one instance of the word “computer.” Expressed as coordinate (<sleep>, <apple>, <computer>), the feature vector can be represented as (1, 2, 1). On the chart, the feature vector is shown as point 407. A radial line from the origin is shown to aid in visualization.

Query 402, “Can I sleep underneath an apple tree?”, has one instance of the word “sleep,” one instance of the word “apple,” and no instances of the word “computer.” The feature vector can be expressed as (1, 2, 0). On the chart the feature vector is shown as point 408.

Query 403, “Whenever my computer goes to sleep, it crashes. It's an Apple computer.” has one instance of the word “sleep,” one instance of the word “apple,” and two instances of the word “computer.” The feature vector can be expressed as (1, 1, 2). On the chart the feature vector is shown as point 409.

Additional dimensions, although more difficult to picture in a drawing figure, can easily be represented by additional numbers in a numerical coordinate. For example, if a fourth dimension represents the keyword “crashes,” then a feature vector for query 403 can be expressed as (1, 1, 2, 1). Any number of dimensions can be tracked and stored in a computer. Dimensions may or may not be orthogonal to each other.

Other ways of determining feature vectors can be used. For example, besides keyword searching, uniform resource identifiers, metatags, and entity extraction can be used. Entity extraction can extract an entity from a document, such as a person, location, time, currency, amount, product, company, etc., or other entities as known by those skilled in the art. Metatags such as the author's name, what group it is in, and other descriptors can be used as well.

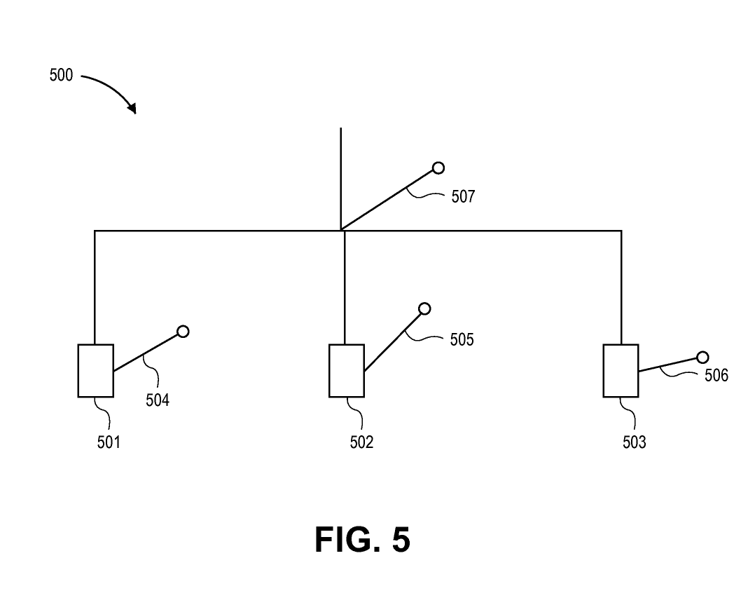

FIG. 5 illustrates a single cluster in accordance with an embodiment. Cluster 500 includes three items, item 501, item 502, and item 503. The items represent queries, emails, instant messages, tweets, white pages, presentations, wiki pages, or other documents. Items 501, 502, and 503 have feature vectors 504, 505, and 506, respectively. Each feature vector is calculated from the content, metatags, and/or context, etc. of its corresponding item.

In the figure, feature vector 505 is shown in a slightly different position than (i.e., higher) than feature vector 504. This merely represents that the feature vectors of items 501 and 502 are different but relatively similar to each other. For example, items 501 and 502 may be different in that one has a certain keyword that the other does not. Similarly, feature vector 506 is slightly different, indicating that item 503 is different but relatively similar to items 501 and 502. The quantitative similarity of the documents can be obtained by comparing their feature vectors to one another.

The angles between the feature vectors can be compared, and if the angle is below some threshold, then the underlying documents can be considered similar to one another.

Alternatively, the ‘distance’ between the feature vectors can be compared, and if the distance is below some threshold, then the underlying documents can be considered similar to one another. A distance can be calculated between two n-dimensional vectors using an equation such as:

distance=SQRT((x₁−y₁)²+(x₂−y₂)²+(x₃−y₃)²+(x₄−y₄)²+ . . . +(x_{N}−y_{N})²)

Other ways of determining similarities between multivariable vectors would be apparent to one skilled in the art.

A representative vector can be assigned to a cluster. In cluster 500, representative vector 507 represents all the feature vectors (i.e., feature vectors 504, 505, and 506) of the cluster. Representative vector 507 can be an average, median, or other mathematical combination of the vectors below it. Alternatively, representative vector 507 can be one particular, representative of the feature vectors or a combination of a subset of the vectors below it. In this case, it could be that feature vector 504 was simply copied and used as representative vector 507. Simply picking one vector from the cluster can save on processing time.

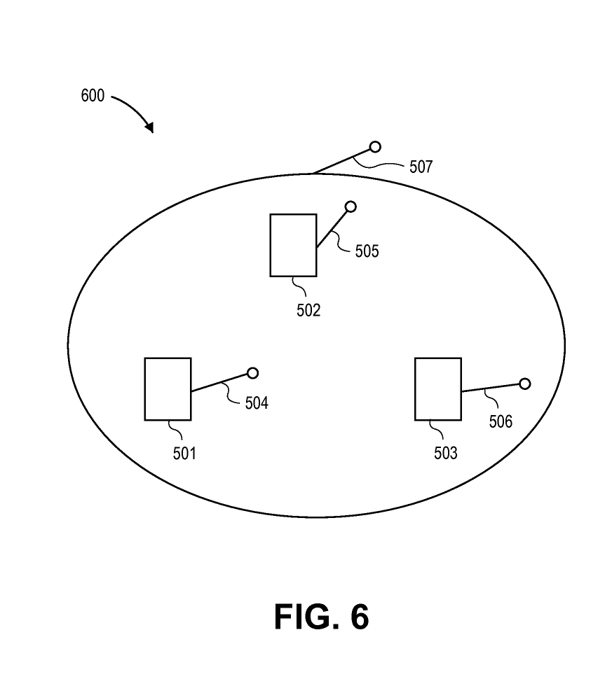

FIG. 6 is an alternate representation of the cluster of FIG. 5. Cluster 600, akin to cluster 500, includes items 501, 502, and 503 with feature vectors 504, 505, and 506, respectively. At the cluster level, representative vector 507 represents all the feature vectors below it in the cluster.

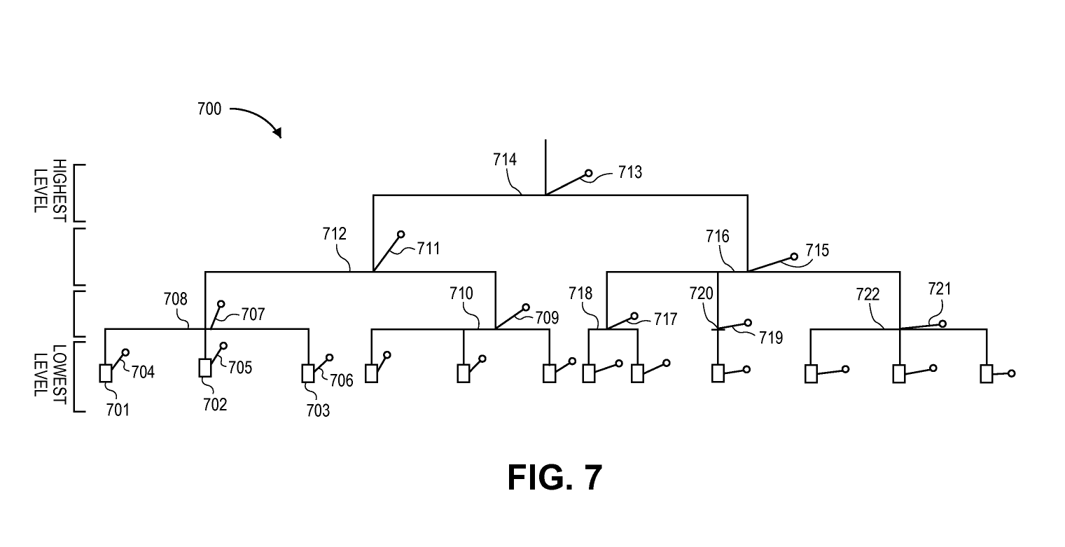

FIG. 7 illustrates a cluster hierarchy in accordance with an embodiment. Cluster hierarchy 700 has several levels of clusters within clusters. Cluster hierarchy 700 is shown with cluster leaves all at an equal level, but other cluster hierarchies can have differing levels of clustering as appropriate.

Cluster 708 includes three items: items 701, 702, and 703, with feature vectors 704, 705, and 706, respectively. Cluster 708 has representative vector 707, which represents all the items in the cluster. Cluster 708, because it is at the lowest level of the hierarchy and/or directly holds items, can be considered a “leaf cluster.”

Cluster 710 has representative vector 709, which represents the three items in the cluster. Like representative vector 707 for cluster 708, representative vector 709 represents all the items in cluster 710.

Branch cluster 712 has representative vector 711. Representative vector 711 can be the average, median, etc. of the representative vectors of the levels below it, i.e., representative vectors 707 and 709. A representative vector can alternatively be the average, median, etc. of the feature vectors of all the documents below it, although this may be computationally more expensive.

At the fourth and highest level up in cluster hierarchy 700 is representative vector 713, which represents all the representative vectors of the levels below it. This includes both the clusters on the cluster 712 side as well as the clusters on the 716 side. Representative vector 717 represents the feature vectors of the two items in cluster 718, representative vector 719 represents the feature vector of the one item in cluster 720, and representative vector 721 represents the feature vector of the three items in cluster 722.

To traverse cluster hierarchy 700 for a query, a feature vector is calculated for the query. The query's feature vector is then compared at the first level where there are multiple clusters from which to choose, i.e., the second level down. The query's feature vector is compared with representative vectors 711 and 715. The closest feature vector is determined, such as by determining the smallest angle or the nearest distance. For this example, the query's feature vector is found to be closest to representative vector 711. Thus, the closest cluster is cluster 712. Based on this finding, the query's feature vector is then compared with representative vectors 707 and 709. For this example, the query's feature vector is found to be closest to representative vector 707. Thus, the closest cluster is cluster 708. At this point, all of the items in cluster 708 can be returned. That is, items 701, 702, and 703 are returned. If the items are previously submitted questions, then the previously submitted questions are returned as sample questions to the user.

In cases where the leaf cluster has too many items, only the closest items may be returned. For example, the query's feature vector may be compared with feature vectors 704, 705, and 706 to determine which one or two of the three items 701, 702, and/or 703 are closest to the query. Only those one or two items are returned.

In cases where the leaf cluster has too few items, items from multiple leaf clusters can be returned. For example, if six items are desired to be returned, then the items of both leaf clusters 708 and 710 can be returned to the user.

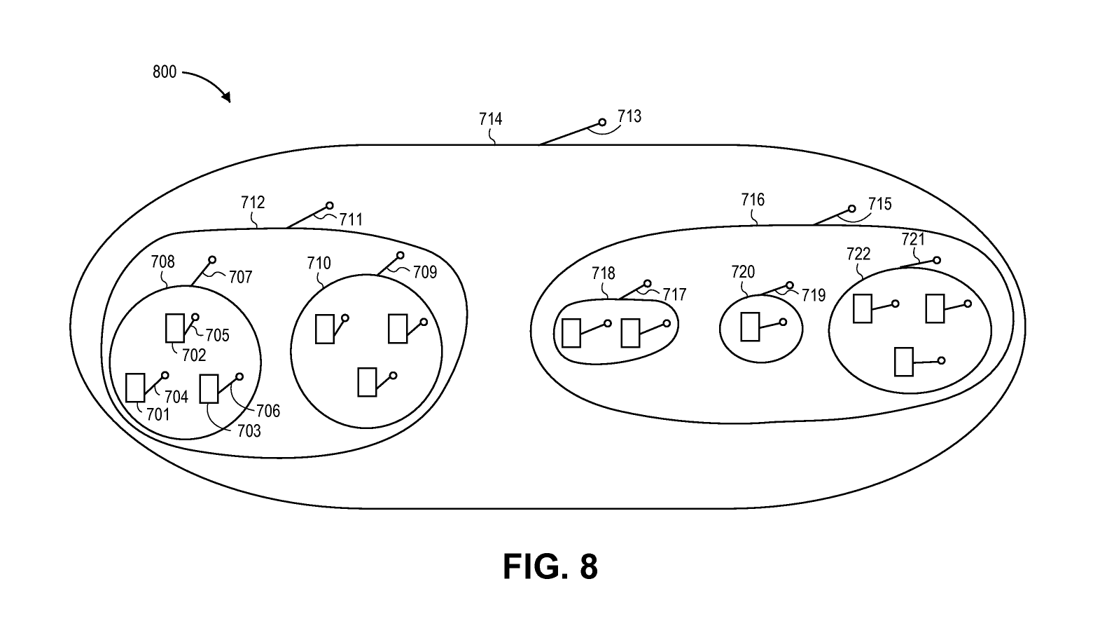

FIG. 8 is an alternate representation of the cluster hierarchy of FIG. 7. Leaf clusters 708 and 710 are within branch cluster 712. Leaf clusters 718, 720, and 722 are within branch cluster 716. Branch clusters 712 and 716 are within cluster 714. Cluster 714 can itself be inside of other clusters.

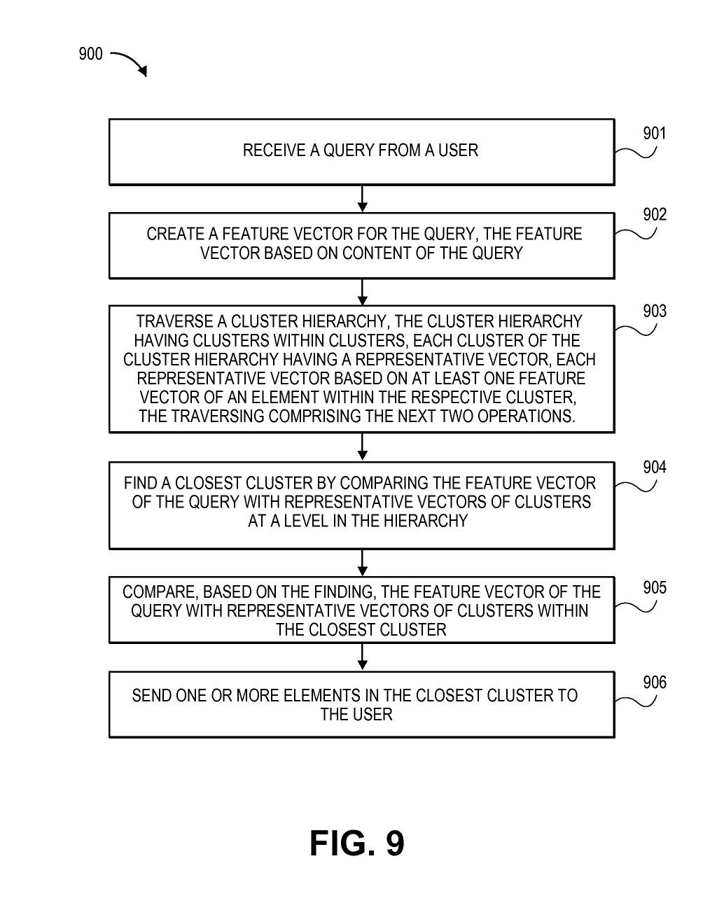

FIG. 9 is a flowchart illustrating a process in accordance with an embodiment. Process 900 can be automated in a computer or other machine and can be coded in software, firmware, etc. In operation 901, a query is received from a user. In operation 902, a feature vector is created for the query, the feature vector based on content of the query. In operation 903, a cluster hierarchy is traversed, the cluster hierarchy having clusters within clusters, each cluster of the cluster hierarchy having a representative vector, each representative vector based on at least one feature vector of an element within the respective cluster. The traversing comprises the next two operations. In operation 904, a closest cluster is found by comparing the feature vector of the query with representative vectors of clusters at a level in the hierarchy. In operation 905, the feature vector of the query is compared with representative vectors of clusters within the closest cluster. In operation 906, one or more elements in the closest cluster are sent to the user.

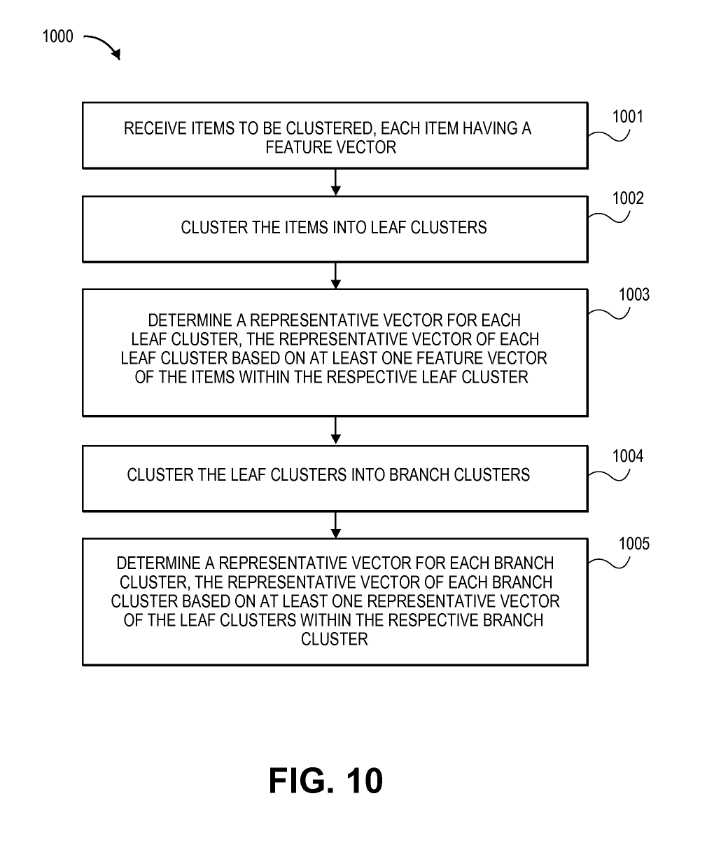

FIG. 10 is a flowchart illustrating a process in accordance with an embodiment. Process 1000 can be automated in a computer or other machine and can be coded in software, firmware, etc. In operation 1001, items to be clustered are received, each item having a feature vector. In operation 1002, the items are clustered into leaf clusters. In operation 1003, a representative vector is determined for each leaf cluster, the representative vector of each leaf cluster based on at least one feature vector of the items within the respective leaf cluster. In operation 1004, the leaf clusters are clustered into branch clusters. In operation 1105, a representative vector is determined for each branch cluster, the representative vector of each branch cluster based on at least one representative vector of the leaf clusters within the respective branch cluster.

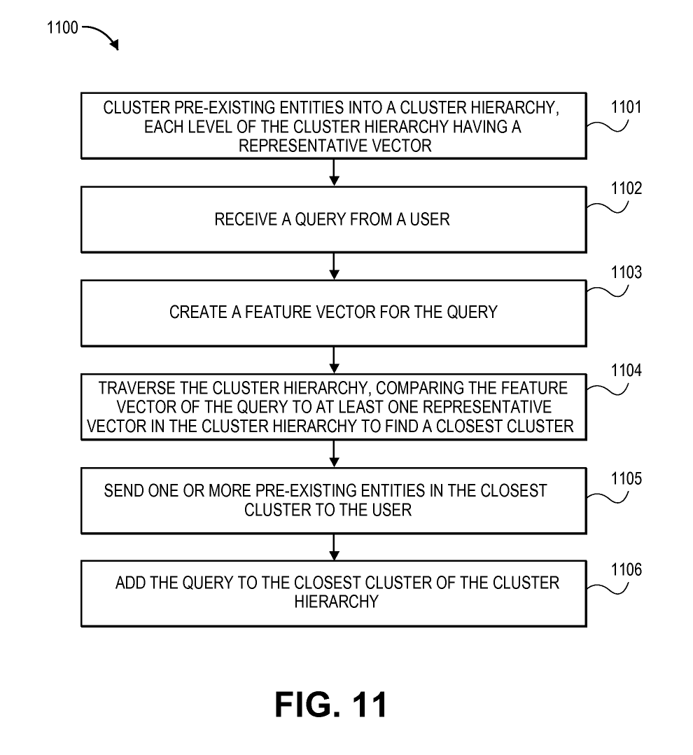

FIG. 11 is a flowchart illustrating a process in accordance with an embodiment. Process 1100 can be automated in a computer or other machine and can be coded in software, firmware, etc. In operation 1101, pre-existing entities are clustered into a cluster hierarchy, each level of the cluster hierarchy having a representative vector. In operation 1102, a query is received from a user. In operation 1103, a feature vector is created for the query. In operation 1104, the cluster hierarchy is traversed, comparing the feature vector of the query to at least one representative vector in the cluster hierarchy to find a closest cluster. In operation 1105, one or more pre-existing entities in the closest cluster are sent to the user. In operation 1106, the query is added to the closest cluster of the cluster hierarchy.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for performing recommendation processing, the method comprising:
receiving a query from a user;
creating a feature vector for the query, the feature vector based on content of the query;
traversing, using a processor operatively coupled with a memory, a cluster hierarchy, the cluster hierarchy having clusters within clusters, each cluster of the cluster hierarchy having a representative vector, each representative vector based on at least one feature vector of an element within the respective cluster, the traversing comprising:
finding a closest cluster by comparing the feature vector of the query with representative vectors of clusters at a level in the hierarchy; and
comparing, based on the finding, the feature vector of the query with representative vectors of clusters within the closest cluster;
sending one or more elements in the closest cluster to the user.

2. The method of claim 1 wherein the elements in the cluster hierarchy are previously-entered queries.

3. The method of claim 1 wherein the feature vector is based upon a number of keywords in the query.

4. The method of claim 1 further comprising:
adding the query to the closest cluster of the cluster hierarchy.

5. The method of claim 1 wherein each representative vector is selected from the group consisting of a mean vector and a median vector.

6. The method of claim 1 wherein the sending is triggered upon a desired number of elements being within the closest cluster.

7. The method of claim 1 wherein the sending is triggered upon the closest cluster being a leaf node of the cluster hierarchy.

8. The method of claim 1 wherein the operations are performed in the order as shown.

9. The method of claim 1 wherein each operation is performed by the computer processor operatively coupled to the memory.

10. A computer system executing instructions in a computer program, the computer program instructions comprising program code for performing the operations of claim 1.

11. A machine-readable tangible storage medium embodying information indicative of instructions for causing one or more machines to perform the operations of claim 1.

12. A method for performing recommendation processing, the method comprising:
clustering pre-existing entities into a cluster hierarchy, each level of the hierarchy having a representative vector;
receiving a query from a user;
creating a feature vector for the query;
traversing, using a processor operatively coupled with a memory, the cluster hierarchy, comparing the feature vector of the query to at least one representative vector in the cluster hierarchy to find a closest cluster; and
sending one or more pre-existing entities in the closest cluster to the user.

13. The method of claim 12 wherein the entities include queries.

14. The method of claim 12 wherein the entities are selected from the group consisting of web pages, presentations, Microsoft Word documents, Adobe Acrobat Portable Document Format (PDF) documents, instant messages, tweets, and emails.

15. The method of claim 12 wherein the creating and traversing occur in real time.

16. A method of building a cluster hierarchy for recommendation processing, the method comprising:
receiving items to be clustered, each item having a feature vector;
clustering, using a processor operatively coupled with a memory, the items into leaf clusters;
determining a representative vector for each leaf cluster, the representative vector of each leaf cluster based on at least one feature vector of the items within the respective leaf cluster;
clustering the leaf clusters into branch clusters; and
determining a representative vector for each branch cluster, the representative vector of each branch cluster based on at least one representative vector of the leaf clusters within the respective branch cluster.

17. The method of claim 16 wherein each item is an electronic document selected from the group consisting of a web log, presentation, Microsoft Word document, Adobe Acrobat Portable Document Format (PDF) document, instant message, tweet, and email.

18. The method of claim 16 wherein each feature vector is based upon a number of keywords in the item.

19. The method of claim 16 wherein each feature vector is based upon an author of the item.

20. The method of claim 16 wherein each feature vector is based upon an extracted entity of the item.
